(19) United States
(12) Patent Application Publication
(10) Pub. No.: US 2009/0231189 A1
(43) Pub. Date: Sep. 17, 2009

(54) VEHICLE TRACKING AND SECURITY USING AN AD-HOC WIRELESS MESH AND METHOD THEREOF

(75) Inventors: Dasari Uday Kumar Reddy, Hyderabad (IN); Kathirisetti Satish, Hyderabad (IN); Chachan Navnit, Hyderabad (IN)

Correspondence Address: ABELMAN, FRAYNE & SCHWAB, 666 THIRD AVENUE, 10TH FLOOR, NEW YORK, NY, 10017, US

(73) Assignee: TANLA SOLUTIONS LIMITED, Hyderabad (IN)

(21) Appl. No.: 12/307,272

(22) PCT Filed: Jul. 3, 2007
(86) PCT No.: PCT/IN07/00270

§ 371 Date: Jan. 1, 2009

(30) Foreign Application Priority Data
Jul. 3, 2006 (IN) IN1145/CHE/2006

(51) Int. Cl. G01S 5/00

(52) U.S. Cl. 342/357.07

(57) ABSTRACT

An automatic tracking and security system has a plurality of mobile nodes, one or more fixed nodes, and a central monitoring station. The plurality of mobile nodes and at least one fixed node configure a wireless ad-hoc mesh network. The central monitoring station uses GPS-assistance data to the plurality of mobile nodes over the wireless ad-hoc mesh network. The plurality of mobile nodes compute the location data using the GPS-assistance data. The plurality of mobile nodes also include one or more security modules which sense an occurrence of a situation and provide situation data. The location data and/or the situation data are dynamically routed over the wireless as-hoc mesh network from the plurality of mobile nodes to the central monitoring station. The central monitoring station automatically processes the location data and/or the situation data and sends a notification to an end user.

### FIELD OF THE INVENTION

The present invention relates to vehicle tracking and security devices, and more specifically, to an automatic tracking and security system which provides location information and security information of a mobile unit, using a wireless ad-hoc mesh network.

### BACKGROUND OF THE INVENTION

With every passing year, there is an increasing movement of goods, personnel and assets from one place to another. It is often desired that location information be available while the goods, personnel or assets are in transit. For instance, a shipping service provider may want to keep track of a fleet of vehicles and more specifically, keep track of packages in the fleet of vehicles. In cases of theft of vehicles, vehicle owners may want to track down the vehicle and apprehend a thief. Personal vehicle owners may also want to track their vehicles for assurance that a driver is at a designated location and is following a prescribed route. The location information may also be desired for tracking personnel, for instance, security personnel deployed in an emergency situation may be tracked using the location information.

Tracking solutions provide location information to track a desired object. Typical tracking solutions include a Geo-Positioning System (GPS) which uses the location information beamed from GPS satellites for tracking purposes. The GPS uses known techniques such as triangulation for arriving at the location information with a fair amount of accuracy. Automated Vehicle Locating (AVL) is one such tracking solution for remote vehicle tracking and monitoring. Automated vehicle Locating (AVL) uses the GPS for arriving at the location information. A vehicle is equipped with an AVL device for receiving signals from the GPS satellites. A GPS receiver in the AVL device determines the vehicle's current location, speed and direction in which the vehicle is heading. This data may then be stored or directly transmitted to a central monitoring station (also known as an operating center).

For providing on-demand information, the tracking solutions require the GPS receiver to be in an activated condition constantly, for tracking the satellites. This results in substantial drain of battery power. Further, switching on the GPS receiver on-demand results in delay in computing the location information as the GPS receiver takes a long time to locate and tune into the GPS satellite and then to process the computations required to extract the parameters for computing the location information. Also, the accuracy for the GPS system is reduced under heavy tree cover, or even indoors as the GPS receiver cannot locate the required number of satellites for triangulation and subsequent computation of the location information.

Typical tracking solutions use a combination of GPS and Global System for Mobile communications (GSM) for tracking purposes. However, such tracking solutions require large capital and operating cost as every node has to be embedded with a GSM module. Moreover, the cost of sending a Short Message Service (SMS) for every location information, security information and control message, adds to the high operating cost. Other tracking solutions make use of satellite communications and fixed wireless communication techniques. However, such tracking solutions entail enormous costs as they involve reserving satellite channel/radio channel and expensive equipment to be attached to each and every unit being tracked.

Further, devices such as the GPS receivers are expensive and have high working cost. Moreover, the working of such devices is complex which proves a hindrance in effective working and requires huge capital investments during hardware or a software upgrade.

Cost-effective solutions, such as those providing means for storing tracking data inside the AVL device, and to be downloaded later via RS232 by connecting the AVL device to a personal computer (PC) are available. However, such systems do not provide on-demand location information.

Further, such tracking solutions do not provide any means to inform or provide notification to a concerned entity in case of events such as a theft of a unit being tracked or a detected intrusion. Moreover, such tracking solutions fail to respond to an occurrence of such events and as such provide no security.

Based on the problems mentioned above with regard to the tracking solutions, there exists a need for a system that provides on-demand location information of a unit to an end user requesting the location information. Further, the system needs to reduce the time to compute the location information and provide the location information in a cheap and efficient manner. Moreover, the system needs to provide means for notification to the end user of an occurrence of a situation and/or provide means to secure the unit being tracked

Also, what is needed is a system that provides on-demand location information in a power-efficient manner.

### SUMMARY OF THE INVENTION

An object of the present invention is to provide on-demand notification of a location of a mobile unit and/or occurrence of a situation, to an end user.

Another object of the present invention is to reduce the time involved in the computation of the location of the mobile unit.

Yet another object of the present invention is to provide an automatic tracking and security system that has low power consumption.

Still another object of the present invention is to provide an automatic tracking and security system which is cost-effective and does not involve large capital and operating cost.

Yet another object of the present invention is to provide an automatic tracking and security system which provides means to secure the mobile unit being tracked.

In view of the foregoing disadvantages inherent in the prior art, the general purpose of the present invention is to provide an automatic tracking and security system providing a notification to an end user, using a wireless ad-hoc mesh network to include all the advantages of the prior art, and to overcome the drawbacks inherent therein. The automatic tracking and security system comprises a plurality of mobile nodes and the one or more fixed nodes configure a wireless ad-hoc mesh network. The wireless ad-hoc mesh network is in operative communication with the central monitoring station. The central monitoring station calculates a GPS assistance data and provides the GPS assistance data to the plurality of mobile nodes using the wireless ad-hoc mesh network. The plurality of mobile nodes compute a location data using the GPS assistance data received over the wireless ad-hoc mesh network. The plurality of mobile nodes may also include one or more security modules. The one or more security modules sense occurrence of a situation and provide situation data. The location data and/or the situation data is dynamically routed over the wireless ad-hoc mesh network from the mobile node to the central monitoring station. The central monitoring station automatically processes the location data and/or the situation data and provides the notification to the end user. The notification may comprise location of a mobile node and/or the occurrence of the situation. The notification may be provided to the end user in response to request for the notification by the end user. Thus the automatic tracking and security system provides the notification of location of a mobile node and/or the occurrence of the situation to the end user, on-demand.

Further, the plurality of mobile nodes do not have to locate and tune to a GPS satellite to compute the location data, as they receive the GPS assistance data from the central monitoring station. This greatly reduces the time required to compute the location data. Moreover, as the central monitoring station provides the GPS assistance data, a GPS receiver in each of the plurality of mobile nodes need not be kept in a constantly activated mode to track the GPS satellites. The GPS receiver can be switched off and activated only when the location data is desired. In such a case, the GPS receiver wakes up, receives the GPS assistance data and calculates the location data. Thus, the GPS receiver may be switched off and may be activated only when the location data is desired, resulting in substantially lowering power consumption.

The wireless ad-hoc mesh network is capable of adapting itself to failure of at least one of the plurality of mobile nodes and the one or more fixed nodes. The wireless ad-hoc mesh network is also capable of determining new mobile nodes and/or fixed nodes and integrating them in the wireless ad-hoc mesh network. This provides the necessary flexibility to the automatic tracking and security system, as the the wireless ad-hoc mesh network. Further, the wireless ad-hoc mesh network precludes laying expensive cables, making modifications to the existing set-up or embedding each mobile node with a GSM module. This results in substantially lower cost. Moreover, operating cost is also reduced as the location data is dynamically routed over the wireless ad-hoc mesh network precluding the need to send SMS messages.

In one aspect of the present invention, the automatic tracking and security system is capable of sending control messages from the end user of the automatic tracking and security system to the mobile node being tracked and may modify the state of the mobile node. For instance, in case of theft of a vehicle, the automatic tracking and security system may immobilize an ignition of the vehicle, thereby securing the vehicle.

These together with other aspects of the present invention, along with the various features of novelty that characterize the invention, are pointed out with particularity in the claims annexed hereto and form a part of this disclosure. For a better understanding of the invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a block diagram of an automatic tracking and security system, in accordance with various embodiments of the present invention;

FIG. 2 is a block diagram of a mobile node, in accordance with an embodiment of the present invention;

FIG. 3 is a block diagram of a fixed node, in accordance with an embodiment of the present invention;

FIG. 4 is a block diagram of a central monitoring station, in accordance with an embodiment of the present invention;

FIG. 5 illustrates a message structure of a Location Request data packet, in accordance with an embodiment of the present invention;

FIG. 6 illustrates a message structure of a GPS Assistance data packet, in accordance with an embodiment of the present invention; and

FIG. 7 illustrates a message structure of a GPS Tracker data packet, in accordance with an embodiment of the present invention;

FIG. 8 is a flow diagram illustrating a method for providing notification to an end user of an automatic tracking and security system, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes and are subject to many variations in structure and design. It should be emphasized, however, that the present invention is not limited to a particular automatic tracking and security system, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The terms “a” and “an” herein do not denote a limitation of quantity, but rather denote the presence of at least one of the referenced item.

The present invention provides a system and a method for providing location information and security information of a mobile unit, using a wireless ad-hoc mesh network. The system comprises a plurality of mobile nodes, one or more fixed nodes and a central monitoring station. The plurality of mobile nodes and the one or more fixed nodes configure a wireless ad-hoc mesh network. The wireless ad-hoc mesh network is in operative communication with the central monitoring station. The central monitoring station calculates a GPS assistance data and provides the GPS assistance data mobile nodes compute a location data using the GPS assistance data received over the wireless ad-hoc mesh network. The plurality of mobile nodes may also include one or more security modules. The one or more security modules sense occurrence of a situation and provide situation data. The location data and/or the situation data is dynamically routed over the wireless ad-hoc mesh network from the mobile node to the central monitoring station. The central monitoring station automatically processes the location data and/or the situation data and provides a notification to the end user. The notification may comprise location of a mobile node and/or the occurrence of the situation. The notification may be provided to the end user in response to request for location information and/or security information by the end user.

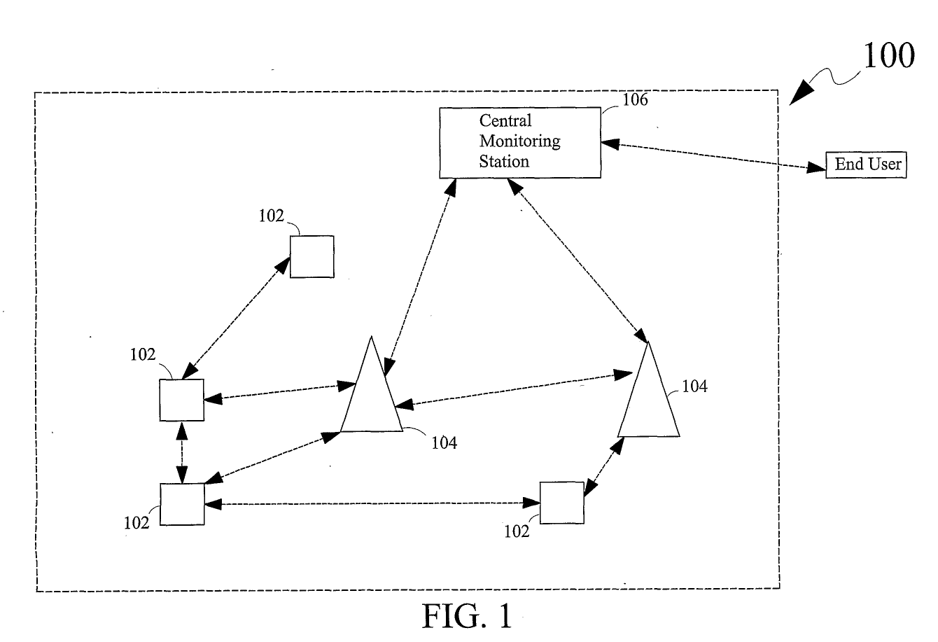

FIG. 1 is a block diagram of an automatic tracking and security system (hereinafter referred to as system 100), in accordance with various embodiments of the present invention. The system 100 includes a plurality of mobile nodes such as mobile node 102, one or more fixed nodes such as fixed node 104 and a central monitoring station 106. The one or more fixed nodes 104 configure a fixed mesh network. The plurality of mobile nodes 102 and the fixed mesh network of the one or more fixed nodes 104 configure a wireless ad-hoc mesh network. The central monitoring station 106 operably communicates with the wireless ad-hoc mesh network.

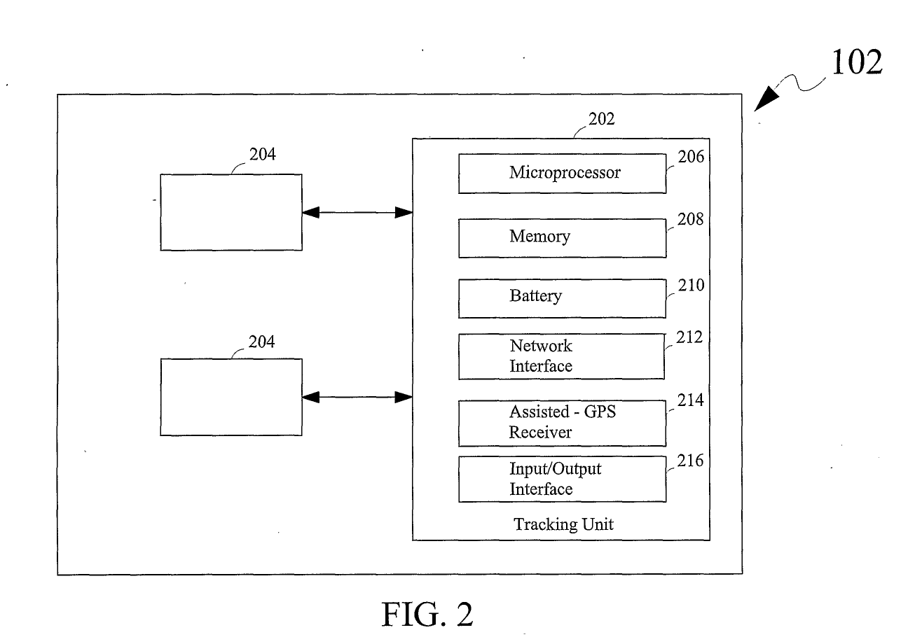

Referring to FIG. 2, is a block diagram of a mobile node 102 (of the plurality of mobile nodes 102 shown in FIG. 1), in accordance with an embodiment of the present invention. The mobile node 102 includes a tracking unit 202 and one or more security modules, such as security module 204. The tracking unit 202 comprises a microprocessor 206, a memory 208, a battery 210, a network interface 212, an assisted GPS receiver 214, and an input/output (I/O) interface 216. The microprocessor 206 is capable of executing programmable instructions for performing operations of the tracking unit 202. The operations of the tracking unit 202 may include, but are not limited to, handling requests for a notification and reception of a control data. The microprocessor 206 may take a form of an integrated chip that has all the components of a microprocessor, i.e., a central processing unit (CPU), a random access memory (RAM), a read only memory (ROM), and timer circuits. Alternatively, the microprocessor 206 may be implemented as a software program. The memory 208 is capable of storing the necessary programmable instructions and data structures located on the tracking unit 202. The memory 208 may take the form of a memory card, memory stick, compact flash, and the like.

The battery 210 supplies power to the tracking unit 202. The battery 210 may take the form of a non-rechargeable battery or a rechargeable battery. Examples of the non-rechargeable battery may include, but not limited to, an alkaline battery and a zinc-chloride battery. Examples of the rechargeable battery may include, but not limited to, a lead-acid based battery, an absorbed glass mat (AGM) based battery, a Nickel Cadmium battery and a Nickel Metal Hydride battery. Further, suitable electrical circuits and electrical connections may be provided to enable functions, such as recharging of the battery 210 by using, for example, solar energy, a DC power input, and the like.

The mobile node 102 communicates with the other mobile nodes 102 and fixed nodes 104 using the network interface 212. More specifically, the network interface 212 couples the mobile node 102 to the wireless ad-hoc mesh network, the wireless ad-hoc mesh network configured by the plurality of mobile nodes 102 and one or more fixed nodes 104. A request for the notification sent by the central monitoring station 106 to the mobile node 102 over the wireless ad-hoc mesh network is received by the mobile node 102 using the network interface 212. The network interface 212 also serves as an interface for transmitting the location data and/or the situation data to the central monitoring station 106 over the wireless ad-hoc mesh network. Further, the network interface 212 may also serve as an interface for receiving a control data from the central monitoring station 106 dynamically routed over the wireless ad-hoc mesh network. The network interface 212 may include a wireless transceiver to couple the mobile node 102 with the wireless ad-hoc mesh network. An example of the wireless transceiver may be a low power/low range Radio Frequency (RF) transceiver, and the like.

The central monitoring station 106 provides a GPS assistance data to the mobile node 102 over the wireless ad-hoc mesh network. The one or more fixed nodes 104 in the wireless ad-hoc mesh network receive the GPS assistance data sent by the central monitoring station 106. The one or more fixed nodes 104 broadcast the GPS assistance data over the wireless ad-hoc mesh network. The mobile node 102 receives the GPS assistance data from the one or more fixed nodes 104 over the wireless ad-hoc mesh network using the Assisted-GPS (A-GPS) receiver 214. The A-GPS receiver 214 computes the location data using the GPS assistance data. The computed location data is then dynamically routed over the wireless ad-hoc mesh network from the mobile node 102 to the central monitoring station 106, using the network interface 212. The A-GPS receiver 214 may include the necessary programmable instructions for performing operations like computing the location data.

Further, the A-GPS receiver 214 goes through a periodic sleep/wake-up cycle to conserve power. The A-GPS receiver 214 wakes up at periodic intervals and receives the GPS assistance data broadcast over the wireless ad-hoc mesh network and computes the location data. As the A-GPS receiver 214 receives the GPS assistance data for calculation of the location data, time required for the computation of the location data is greatly reduced as it does not need to track GPS satellites and tune to a GPS satellite to receive location information, which adds to the time required to compute the location data. Moreover, as the A-GPS receiver 214 may be switched OFF and activated only when the location data is desired, substantial reduction in power consumption is achieved.

In accordance with an embodiment of the present invention, the end user of the system 100 may send the request for the notification to the central monitoring station 106. The request for the notification may include location information of a mobile node 102 desired by the end user. The central monitoring station 106 dynamically routes the request for the notification to the respective mobile node 102. The central monitoring station 106 also provides the GPS assistance data to one or more fixed nodes 104 which dynamically route the GPS assistance data to the mobile node 102. On receiving the request for the notification, the A-GPS receiver 214 wakes up from a sleep mode and computes the location data using the GPS assistance data. The computed location data is dynamically routed over the wireless ad-hoc mesh network from the mobile node 102 to the central monitoring station 106, which then processes the location data and provides the notification to the end user of system 100.

In accordance with an embodiment of the present invention, the mobile node 102 communicates directly with the central monitoring station 106 using the 106 to the mobile node 102 is received by the mobile node 102 using the network interface 212. Moreover, the mobile node may also receive the GPS assistance data directly from the central monitoring station 106 using the network interface 212. Further, the network interface 212 may also serves as an interface for transmitting the location data and/or a situation data to the central monitoring station 106.

The tracking unit 202 communicates with the security module 204 using the input/output interface 216. The input/output interface 216 constantly monitors the security module 204 for receiving the situation data. Further, the input/output interface 216 also serves as an interface for transferring the control data from the tracking unit 202 to the security module 204. A wired connection or a wireless link couple the input/output interface 216 of the tracking unit 202 to the security module 204. Examples of wired connection may include cables, electric wires, and the like. Examples of the wireless link may include an optical, an infra-red, a low power radio frequency (RF) transceiver, and the like.

The security module 204 may be in a form of a security device such as sensor, for example, a motion sensor, a vibration sensor, an impact sensor, a pollution sensor, a temperature sensor, a humidity sensor, an imaging device, and the like. One or more of the security modules 204 may be installed at various locations in the mobile node 102. As used herein, the mobile node 102 may be in a form of any object capable of movement such as but not limited to a vehicular unit like a personal vehicle, a cargo truck and the like. In accordance with an embodiment of the present invention, the mobile node 102 may be personnel carrying a mobile tracking unit such as tracking unit 202. The mobile node 102, in this case, does not include the security module 204. Moreover, the tracking unit 202 may be a portable hand-held unit.

The security module 204 senses the mobile node 102 for occurrence of a situation and provides the situation data to the tracking unit 202 coupled with the security module 204 on sensing the occurrence of the situation. Examples of situation may include, but are not limited to a completion of a periodic interval for checking fuel gauge or tire pressure and the like; a broken door or window; detection of tampering with the one or more security modules 204, and presence of intruder in the premise. Examples of situation data may include: fuel gauge readings; tire pressure information; alert data such as a siren or an alarm bell indicating an intrusion in a premise; theft or tampering of the one or more security module 204; and the like.

The central monitoring station 106 receives the location data and/or the situation data from the mobile node 102. Examples of the location data may include a latitude and longitude co-ordinates of the mobile node 102 or other location indicators of the mobile node such as a city or street name and the like. The central monitoring station 106 automatically processes the location data- and/or the situation data and provides the notification to the end user of the system 100. The notification may be sent in the form of a pop-up on the end user's personal computer, a Short Message Service (SMS), a Multimedia Message Service (MMS), a text message or a video call on the end user's mobile phone, and the like. The end user of the system 100 may be a subscriber (vehicle-owner, security personnel, and the like) to the system 100, or any person suggested by the subscriber of the system 100. The notification may be sent to the end user on a variety of communication networks including wireless networks, power-line networks, fixed wireless networks, wired networks, cellular networks such as GSM/GPRS/3G/CDMA, and similar communications networks.

The mobile node 102 communicates wirelessly with other mobile nodes 102 and one or more fixed nodes 104 using the network interface 212 in the tracking unit 202. Using the network interface 212, the mobile node 102 may function as a receiver, a repeater, and a transmitter to the other mobile nodes 102 and the one or more fixed nodes 104, thereby creating a communication network, more specifically the wireless ad-hoc mesh network comprising the plurality of mobile nodes 102 and one or more fixed nodes 104.

The wireless ad-hoc mesh network has self-healing characteristics, i.e., the wireless ad-hoc mesh network is capable of adapting itself to failure of one or more of the mobile nodes 102 and/or one or more fixed nodes 104. For example, during transmission of the location data and/or the situation data, if one or more of the mobile nodes such as the mobile node 102 fails, then the wireless ad-hoc mesh network removes such a failed mobile node 102 and defines an alternate path for dynamically routing the location data and/or the situation data to the central monitoring station 106. Additionally, failed mobile nodes 102 or failed fixed nodes 104 may be integrated into the wireless ad-hoc.

Further, the wireless ad-hoc mesh network has self-creating and self-determining characteristics i.e., the wireless ad-hoc mesh network is capable of determining newly added mobile nodes, integrating the newly added mobile nodes (such as the mobile node 102) into the wireless ad-hoc mesh network, and updating existing paths for dynamically routing the location data and/or the situation data to the central monitoring station 106. In accordance with an embodiment of the present invention, the wireless ad-hoc mesh network defines a route based on a shortest reliable path algorithm, for dynamically routing the location data and/or the situation data at a given point of time.

In accordance with an embodiment of the present invention, the central monitoring station 106 may send the control data to the one or more security modules 204 over the wireless ad-hoc mesh network. Examples of control data include immobilizing an ignition, locking doors, sounding an alarm for notifying security personnel in given premise, reset of the security module 204 or control, execute control action, and the like. The control data may be sent by the central monitoring station 106 with or without the suggestion of the end user.

The wireless ad-hoc mesh network configured by the plurality of mobile nodes 102 and one or more fixed nodes 104 therefore support bi-directional communication between the central monitoring station 106 and the mobile nodes 102.

It will be evident to a person skilled in the art that the mobile node 102 may include the requisite electrical circuits and connections to connect the tracking unit 202 and its components such as the microprocessor 206, the memory 208, the battery 210, the network interface 212, the assisted GPS receiver 214, and the input/output (I/O) interface 216; and the security module 204. Further, the network interface 212, the A-GPS receiver 214 and the input/output interface 216 may include interfaces with requisite connections to transmit/receive data such as the location data, the situation data and the control data.

Further, the components of the tracking unit 202 such as the microprocessor 206, the memory 208, the battery 210, the network interface 212, the assisted GPS receiver 214, and the input/output (I/O) interface 216, may be implemented as a hardware module, software module, firmware, or any combination thereof.

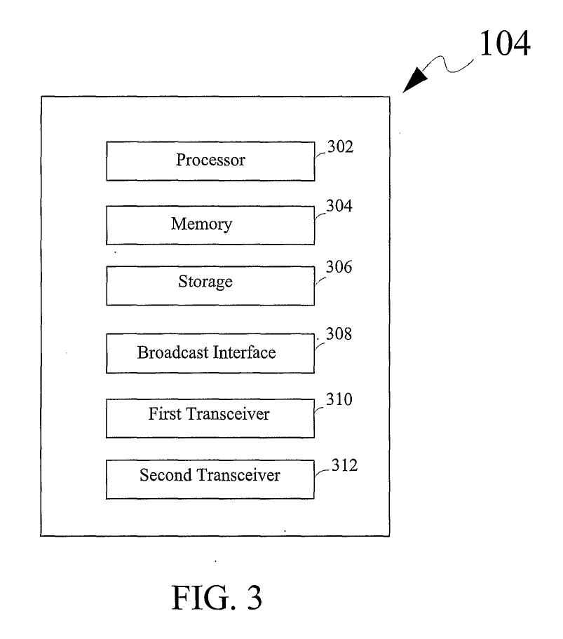

FIG. 3 is a block diagram of a fixed node 104, in accordance with an embodiment of the present invention. The fixed node 104 comprises a processor 302, a memory 304, a storage 306, a broadcast interface 308, a first transceiver 310 and a second transceiver 312. The processor 302 is capable of executing programmable instructions for performing operations of the fixed node 104. In accordance with an embodiment of the present invention, the processor 302 is a hardware module such as a microcontroller or such other integrated chip for executing operations of the fixed node 104. In accordance with another embodiment of the present invention, the processor 302 may be implemented as a software module. Preferably, the memory 304 is a random access memory or other type of dynamic storage device, sufficient to hold the necessary programming and data structures located on the fixed node 104.

The storage 306 provides the fixed node 104 with a means for storing information such as information required for dynamic routing of the location data, situation data and/or the control data. Examples of the storage 306 may include a fixed and/or a removable storage such as tape drives, floppy discs, removable memory cards, or optical storage.

The broadcast interface 308 may be a wireless transceiver such as a radio frequency (RF) modem, GSM modem, or PSTN modem, or a GPRS modem capable of broadcasting a GPS assistance data received from the central monitoring station 106 to the plurality of mobile nodes 102 over a wireless ad-hoc mesh network configured by the plurality of mobile nodes 102 and the one or more fixed nodes such as fixed node 104. The fixed node 104 broadcasts the GPS assistance data to the plurality of mobile nodes 102 over the wireless ad-hoc mesh network, at regular intervals at a specified broadcast frequency. In accordance with an embodiment of the present invention, the fixed node 104 constantly broadcasts the GPS assistance data to the plurality of mobile nodes 102 over the wireless ad-hoc mesh network, at the specified broadcast frequency.

The first transceiver 310 serves as an interface for the fixed node 104 to communicate with the plurality of mobile nodes 102. The request for notification received from the central monitoring station 106 may be forwarded to the mobile node 102 over the wireless ad-hoc mesh network, using the first transceiver 310. Further, the computed location data from the mobile node 102 transmitted over the wireless ad-hoc mesh network is received by the fixed node 104, using the first transceiver 310. The fixed node 104 communicates with other fixed nodes 104 and/or the central monitoring station 106 in the fixed mesh network using the second transceiver 312. The location data and/or situation data may be dynamically routed over to one or more fixed nodes 104 or to the central monitoring station 106 using the second transceiver 312. Examples of the first transceiver 310 may include low power/low range radio frequency (RF) modems, GSM modems, PSTN modems, GPRS modems, and the like. The second transceiver 312 may include interface for communicating with the central monitoring station 106 wirelessly or using a wired connection. Examples of second transceiver 312 for the wireless connection may include low power/low range radio frequency (RF) modems, GSM modems, PSTN modems, GPRS modems and the like. The second transceiver 312 may include interface for coupling the fixed node 104 to a wired connection such as a world wide web, a power line connection, a Wide Area Network (WAN), and the like.

In accordance with an embodiment of the present invention, the fixed node 104 uses multiple frequencies for communication purposes such as a frequency each for broadcasting the GPS assistance data, for communicating with the plurality of the mobile nodes 102 and for communicating with other fixed nodes 104. Examples of fixed node 104 may include a cellular base station for cellular networks such as GSM/GPRS/3G/CDMA networks, a wireless router, and the like.

In accordance with an embodiment of the present invention, the fixed node 104 acts as an aggregator unit performing functions such as collecting, storing and forwarding the location data and/or the situation data over the wireless ad-hoc mesh network to the central monitoring station 106 or directly relaying the location data and/or the situation data to the central monitoring station 106. In this case, the fixed node 104 gathers the location data and/or the situation data from one or more mobile nodes 102.

It will be evident to a person skilled in the art that the fixed node 104 may include the requisite electrical circuits and connections to connect various components such as the processor 302, the memory 304, the storage 306, the broadcast interface 308, the first transceiver 310 and the second transceiver 312. Further, the include interfaces with requisite connections to transmit/receive the location data, the status data and/or the control data.

Further, the components of the fixed node 104 such as the processor 302, the memory 304, the storage 306, the broadcast interface 308, the first transceiver 310 and the second transceiver 312 may be implemented as a hardware module, software module, firmware or any combination thereof.

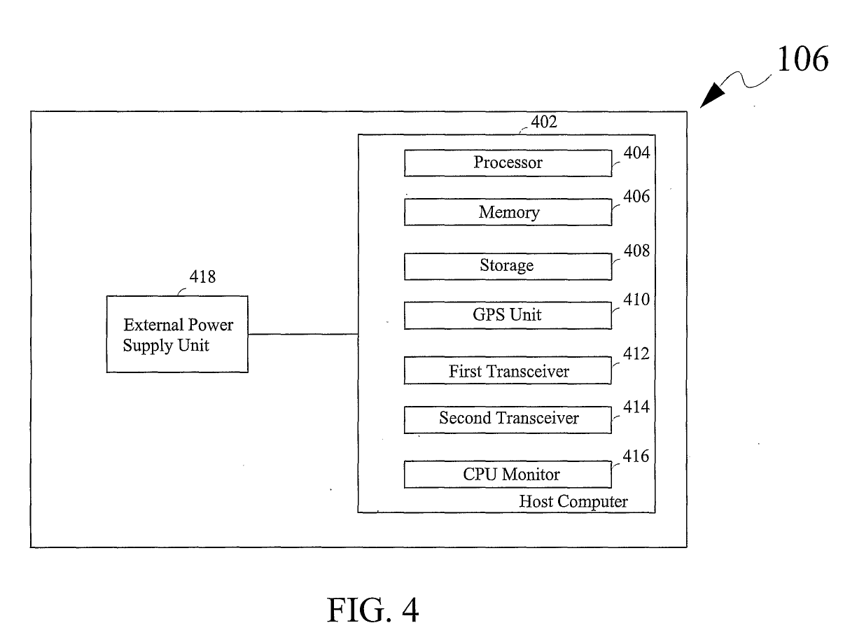

FIG. 4 is a block diagram of the central monitoring station 106, in accordance with an embodiment of the present invention. The central monitoring station 106 includes a host computer 402 capable of processing a location data and/or a situation data and providing a notification to an end user of the system 100. The host computer may take the form of an assistance server computer comprising a processor 404, a memory 406, a storage 408, a GPS unit 410, a first transceiver 412, and a second transceiver 414. The processor 404 is capable of executing programmable instructions for performing operations of the central monitoring station 106. In accordance with an embodiment of the present invention, the processor 404 is a hardware module such as a microcontroller or such other integrated chip for executing operations of the central monitoring station 106. In accordance with another embodiment of the present invention, the processor 404 may be implemented as software module for executing operations of the central monitoring station 106. Preferably, the memory 406 is a random access memory or other type of dynamic storage device, sufficient to hold the necessary programming and data structures located on the central monitoring station 106.

The storage 408 provides the central monitoring station 106 with a means for storing information such as information required for dynamic routing of the location data, the situation data and/or the control data. The storage 408 may include a database to store information such as the mobile node 102 and a corresponding end user information; dynamic routing tables from one mobile node 102 to another or to one or more fixed nodes 104; the security module 204 information such as the type of the security module 204 and the like. Further, the storage 408 may include the requisite software for keeping track of dynamic routing tables controlling data flow in a wireless ad-hoc mesh network configured by the plurality of mobile nodes 102 and one or more fixed nodes 104. Examples of the storage 408 may include a fixed and/or removable

The GPS unit 410 constantly tracks GPS satellites in the sky and calculates a GPS assistance data. The GPS assistance data includes information such as Almanac, Ephemeris, time data and the like. The Almanac includes orbit information of the GPS satellites, clock correction and atmospheric delay parameters, while the Ephemeris includes information such as the position of a satellite in space as a function of time and the like. The GPS assistance data may be dynamically routed over the wireless ad-hoc mesh network from the central monitoring station 106 to the plurality of mobile nodes 102. The Almanac and the Ephemeris information included in the GPS assistance data enables the plurality of mobile nodes 102 to compute the location data in substantially reduced time as the A-GPS receiver such as the A-GPS receiver 214 explained in conjunction with FIG. 2, need not track the GPS satellites for receiving such information.

The first transceiver 412 may be a wireless transceiver such as a radio frequency (RF) modem, or a GSM modem, or a PSTN modem, or a GPRS modem capable of establishing communication between the central monitoring station 106 and one or more fixed nodes such as fixed node 104. Further, the first transceiver 412 may be capable of establishing communication between the central monitoring station 106 and the plurality of mobile nodes 102. In accordance with an embodiment of the present invention, the central monitoring station 106 receives the location data and/or the situation data from one or more fixed nodes 104 using the first transceiver 412. The GPS assistance data to be sent to the plurality of mobile nodes 102 may be relayed by the central monitoring station 106 to the one or more fixed nodes 104 using the first transceiver 412. The one or more fixed nodes 104 may then broadcast the GPS assistance data over the wireless ad-hoc mesh network to the plurality of mobile nodes 102.

The central monitoring station 106 automatically processes the location data and/or the situation data. The automatic processing of the location data may include checking the authenticity of origin of the location data by performing actions such as Cyclic Redundancy Check (CRC); generating a notification including location of a mobile node embedded in Geographic Information System (GIS) maps depicting terrain information to provide visual representation of the location data and the like. Further, the automatic processing of the situation data may include checking the authenticity of origin identifying the type of information included in the situation data such as but not limited to a status information of fuel gauge, tire pressure and the like or an alarm signal; and generating the notification of an occurrence of the situation. The notification including the location of the mobile node 102 and/or the occurrence of the situation may then be provided to an end user using the second transceiver 414.

The second transceiver 414 also serves as an interface for receiving request for the notification from the end user. Further, the second transceiver 414 may receive an instruction from the end user in response to the notification sent by the central monitoring station 106. The central monitoring station 106 may further automatically process the instruction sent by the end user which may include, checking the authenticity of origin of the instruction by performing actions such as the Cyclic Redundancy Check (CRC); identifying the type of information included in the instruction such as securing the mobile node 102, generating an alarm signal; identifying the security module 204 by matching the origin of the instruction and the end user information stored in the storage 408; and generating a control data to be relayed to the security module 204 using the first transceiver 412 over the wireless ad-hoc mesh network. The second transceiver 414 in this case may use a cellular interface such as a GSM/GPRS/3G/CDMA connection to notify the end user by sending a short message service (SMS), a multimedia message service (MMS), a text message, a video clip, a world wide web and the like.

In accordance with an embodiment of the present invention, the central monitoring station 106 may generate the control data on receiving the situation data, based on a pre-defined situation. The pre-defined situation may include receiving instruction from the end user, a situation response defined by the end-user, typical situation responses such as notifying the security personnel in case of an intrusion, and the like. The central monitoring station 106 dynamically routes the control data over the wireless ad-hoc mesh network to the security module 204.

In accordance with an embodiment of the present invention, the wireless ad-hoc mesh network dynamically routes the location data and/or the situation data to the central monitoring station 106 at fixed frequency such as 433 Megahertz (MHz) or at Industrial, Scientific and Medical (ISM) unlicensed radio frequency bands (2.4 Gigahertz). In accordance with another embodiment of the present invention, the ad-hoc mesh network dynamically routes the location data and/or the situation data to the central monitoring station 106 using typical frequency hopping techniques.

In accordance with an embodiment of the present invention, the mobile node 102 dynamically determines the next mobile node to route the location data and/or the situation data. In accordance with an embodiment of the present invention, the central monitoring station 106 updates existing routes for dynamic routing of the situation data and the mobile node 102 routes the situation data based on dynamic routing tables provided by the central monitoring station 106. The central monitoring station 106 updates the existing routes by keeping a track of the mobile nodes 102 and the fixed nodes 104 added or removed from the network.

The host computer 402 may further include a CPU monitor 416 for monitoring the health of the processor 404. The central monitoring station 106 may also include an external power supply unit 418 to supply power for the operation of the host computer 402 and especially the GPS unit 410.

It will be evident to a person skilled in the art that the central monitoring station 106 may include the requisite electrical circuits and connections to connect the processor 404, the memory 406, the storage 408, the GPS unit 410, the first transceiver 412, the second transceiver 414, the CPU monitor 416 and the external power supply unit 418.

Further, the components of the central monitoring station 106, i.e., the processor 404, the memory 406, the storage 408, the GPS unit 410, the first transceiver 412, the second transceiver 414, the CPU monitor 416 and the external power supply unit 418, may be implemented as a hardware module, software module, firmware or any combination thereof.

In accordance with an embodiment of the present invention, the central monitoring station 106 and its components may be implemented as a software program residing in a high end server computer comprising internet connectivity having a public IP address for GPRS, a telephone connectivity for PSTN, and a mobile phone for GSM data call.

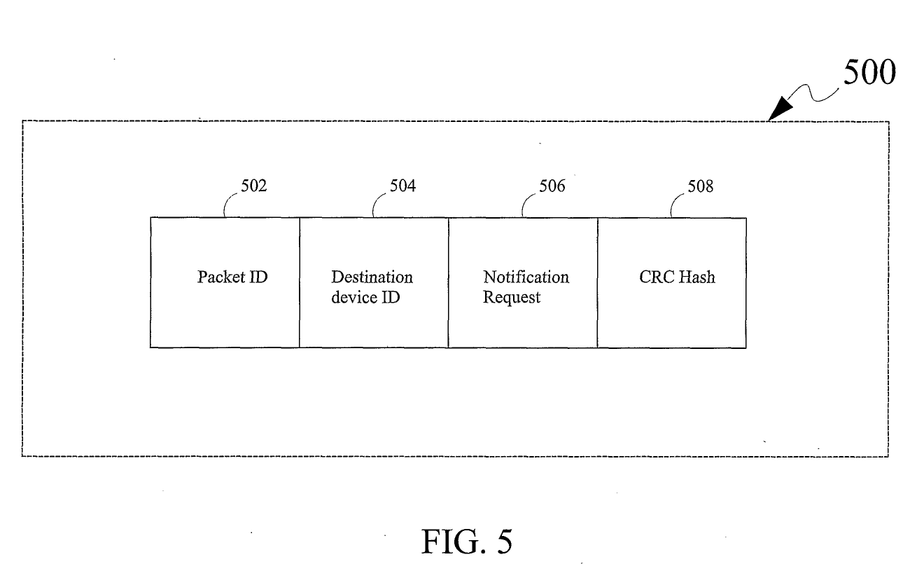

The end user of the system 100 may request location information The request for the notification is received by the system at the central monitoring station 106 using the second transceiver 414. The central monitoring station 106 automatically processes the request for the notification and routes the request for the notification to the corresponding mobile node 102 over the wireless ad-hoc mesh network in the form of a notification request data packet. In addition to the request for the notification, the notification request data packet comprises information for routing the notification request data packet over the wireless ad-hoc mesh network. The transmission of data packets over the wireless ad-hoc mesh network may be governed by methodologies that include, but are not limited to, guaranteed delivery, frequency hopping and the like. The notification request data packet along with its components will be explained in conjunction with FIG. 5.

FIG. 5 illustrates a message structure of a notification request data packet 500 in accordance with an embodiment of the present invention. The notification request data packet 500 includes the following fields, a packet ID 502, a destination device ID 504, a notification request 506 and a CRC Hash 508. The packet ID 502 serves to uniquely identify the notification request data packet 500, thereby avoiding duplicity in its reception and transmission. The destination device ID 504 serves to uniquely identify the mobile node 102 to which the notification request 506 is addressed by the central monitoring station 106, based on the request for the notification provided by an end user of the system 100.

The notification request 506 includes the actual bytes of the request for notification provided by the end user of the system 100. The request for the notification may include request for a location of a mobile node 102 or a request for status of a mobile node 102. The CRC Hash 508 serves to validate the authenticity of the source of the notification request data packet 500. Further the CRC Hash 508 includes the Cyclic Redundancy Bits for error correction and correct decoding of the notification request 506.

In one exemplary embodiment, the end user of the system 100 desiring a location of a mobile node places a request for a notification with the central monitoring station 106. The central monitoring station 106 automatically processes the request for the notification and dynamically routes the request for the notification in the form of notification request data packet 500. The notification request data packet 500 may be routed over a wireless ad-hoc mesh network such as the wireless ad-hoc mesh network (explained in conjunction with FIG. 2) to the mobile node 102. At every hop in the wireless ad-hoc mesh network, the mobile node 102 or the fixed node 104 may first ascertain the uniqueness of the notification request data packet 500 using the packet ID 502. Once the uniqueness is ascertained, the mobile node 102 or the fixed node 104 may determine the next hop for the notification request data packet 500 using the destination device ID 504. The process continues till the notification request data packet 500 reaches the mobile node 102 whose location data was desired. The mobile node 102 in this case decodes the location request using the CRC Hash 508 to decode the request for the notification included in the notification request data packet 500 and computes the location data using the GPS assistance data.

In accordance with an embodiment of the present invention, the number of bytes in the notification request data packet 500 may vary and as such equal the number of bytes corresponding to the information contained in the data packet 500. In an alternative embodiment, the number of bytes in the notification request data packet 500 may be a fixed number.

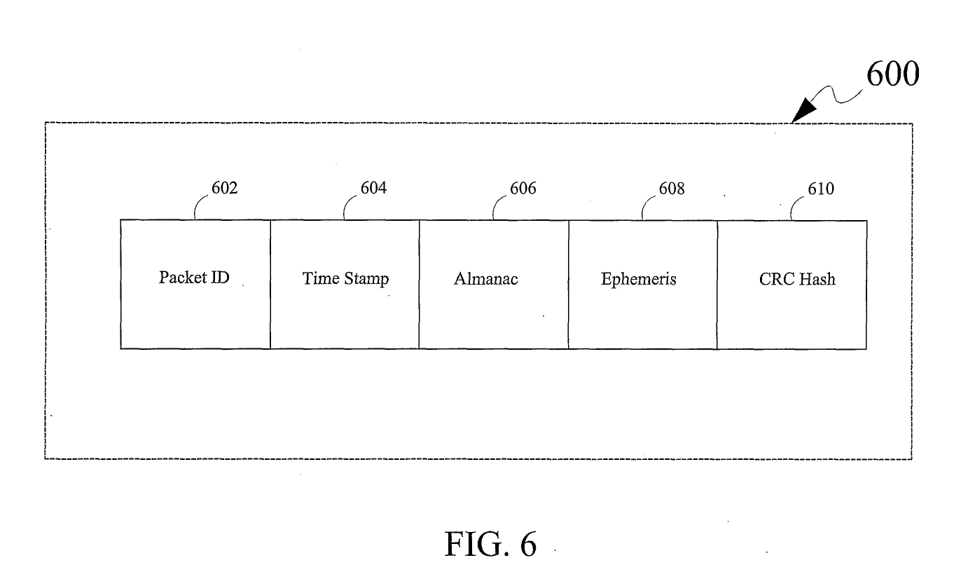

FIG. 6 illustrates a message structure of a GPS Assistance Broadcast data packet 600, in accordance with an embodiment of the present invention. The GPS Assistance Broadcast data packet 600 includes the following fields, a packet ID 602, a time stamp 604, an Almanac 606, an Ephemeris 608 and a CRC Hash 610. The packet ID 602 serves to uniquely identify the GPS Assistance Broadcast data packet 600, thereby avoiding duplicity in its reception and transmission. The time stamp 604 includes date and time (accurate to the order of milliseconds) information. The time stamp 604 aids in calculating and predicting the position of GPS satellites in conjunction with the Almanac 606 and the Ephemeris 608. As explained in conjunction with FIG. 4, the Almanac 606 includes the orbit information of the GPS satellites, clock correction and atmospheric delay parameters while the Ephemeris 608 includes information such as the position of a satellite in space as a function of time.

The CRC hash 610 includes the Cyclic Redundancy Bits for error correction and correct decoding of the GPS Assistance Broadcast data using the time stamp 604, the Almanac 606 and the Ephemeris 608.

In one exemplary embodiment, the central monitoring station 106 calculates the GPS assistance data using the GPS unit as explained in conjunction with FIG. 4. The GPS assistance data is routed to one or more fixed nodes 104 for broadcasting the GPS assistance data over the wireless ad-hoc mesh network to the plurality of mobile nodes. The fixed node 104 broadcasts the GPS assistance data over the wireless ad-hoc mesh network in the form of the GPS Assistance Broadcast data packet 600. The A-GPS receiver such as the A-GPS receiver 214 in the mobile node 102 wakes up on receiving the notification request data packet such as the notification request data packet 500 and receives the GPS Assistance Broadcast data packet 600. On ascertaining the uniqueness of the GPS Assistance Broadcast data packet 600 using the packet ID 602, the mobile node uses the CRC Hash 610 to correctly decode the time stamp 604, the Almanac 606 and the Ephemeris 608. The A-GPS receiver 214 then calculates the location data using the time stamp 604, the Almanac 606 and the Ephemeris 608.

In accordance with an embodiment of the present invention, the number of bytes in the GPS Assistance Broadcast data packet 600 may vary and as such equal the number of bytes corresponding to the information contained in the GPS Assistance Broadcast data packet 600. In an alternative embodiment, the number of bytes in the GPS Assistance Broadcast data packet 600 may be a fixed number.

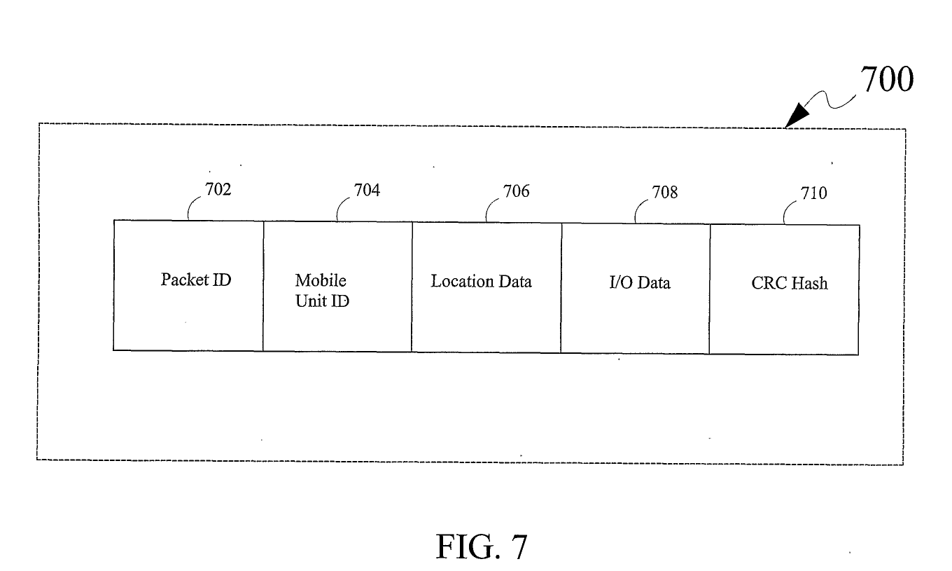

FIG. 7 illustrates a message structure of a GPS Tracker data packet 700, in accordance with an embodiment of the present invention. The GPS Tracker data packet 700 includes the following fields, a packet ID 702, a mobile unit ID 704, a location data 706, an input/output data 708 and a CRC Hash 710. The packet ID 702 serves to uniquely identify the GPS Tracker data packet 700, thereby avoiding duplicity in its reception and transmission. The mobile unit ID 704 serves to uniquely identify the mobile node 102 whose location data 706 is being provided to the end user in the GPS Tracker data packet 700. The location data 706 contains actual bytes containing the location data of the mobile node 102. Examples of location data may include latitude and longitude co-ordinates of the mobile node 102, geographical location such as a name of a city, a street, and the like. The input/output data 708 may include situation data of an occurrence of a situation sensed by one or more security modules such as the security module 204 or status information of the security modules 204. The status information of the security modules 204 may include ON/OFF status of the security modules 204 or fuel gauge meter reading or sensed tired pressure and the like, corresponding to each security module 204.

The CRC hash 710 includes the Cyclic Redundancy Bits for error correction and correct decoding of the location data 706 and the input/output data 708 in the GPS Tracker data packet 700.

In one exemplary embodiment, A-GPS receiver such as the A-GPS receiver 214 in the mobile node 102 calculates the location data 706 in accordance with the National Marine Electronics Association (NMEA) guidelines. The mobile node 102 then transmits the location data 706 along with the input/output data 708 over the wireless ad-hoc mesh network to the central monitoring station 106 in the form of the GPS tracker data packet 700. The central monitoring station 106 on receiving the GPS Tracker data packet 700 automatically processes the location data 706 and the input/output data 708. The central monitoring station 106 accordingly provides a notification to the end user of the system 100.

In accordance with an embodiment of the present invention, the number of bytes in the GPS Tracker data packet 700 may vary and as such equal the number of bytes corresponding to the information contained in the GPS Tracker data packet 700. In an alternative embodiment, the number of bytes in the GPS Tracker data packet 700 may be a fixed number.

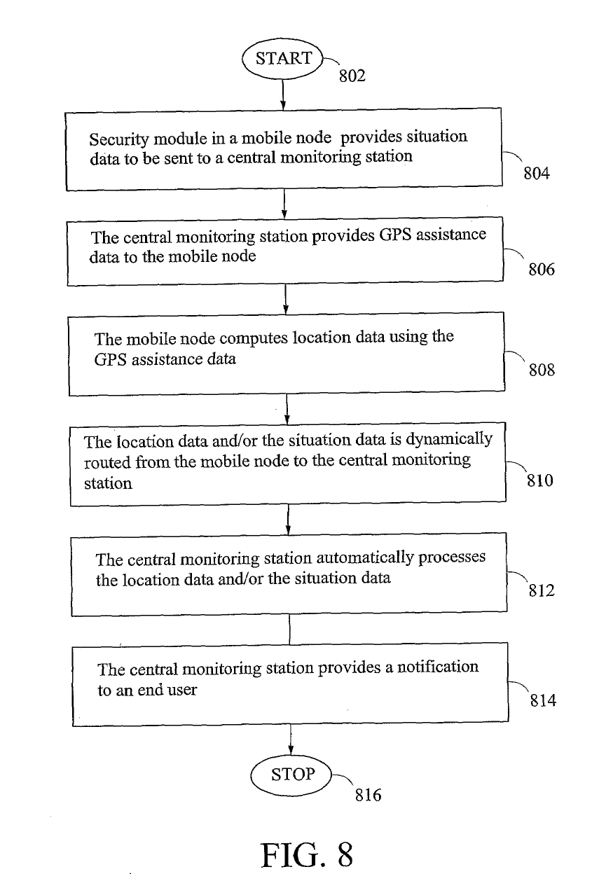

FIG. 8 is a flow diagram illustrating a method for providing a notification to an end user, in accordance with an embodiment of the invention. The method initiates at step 802 on the reception of a request for notification such as notification request data packet 500 by the mobile node such as mobile node 102 from a central monitoring station such as central monitoring station 106. The end user of the system 100 provides the request for notification to the system 100 and is received by the system 100 at the central monitoring station which then relays the request to the mobile node. At step 804, one or more security modules such as security module 204 sense the mobile node for an occurrence of a situation and provide situation data to be sent to the central monitoring station. At step 806, a central monitoring station provides GPS assistance data to the mobile node over a wireless ad-hoc mesh network configured by a plurality of mobile nodes and one or more fixed nodes such as the fixed node 104. At step 808, the mobile node computes a location data using the received GPS assistance data. The A-GPS receiver such as A-GPS receiver 214 in the mobile node receives the GPS assistance data and calculates the location data. At step 810, the location data and/or the situation data is dynamically routed over the wireless ad-hoc mesh network from the mobile node to the central monitoring station. At step 812, the central monitoring station automatically processes the location data and/or the situation data. At step 814, the central monitoring station provides a notification to the end user. At step 816, the method ends when the end user of the system receives the notification from the central monitoring station.

The end user on receiving the notification may send instruction to the central monitoring station. The central monitoring station may then generate control data based on the instruction received from the end user. Alternatively, the central monitoring station may generate the control data based on some pre-defined situation. For instance, the pre-defined situation may be detection of an intrusion, or sensed tampering with the one or more security modules and the like. The central monitoring station may then route the control data over the wireless ad-hoc mesh network to the one or more security modules. The one or more security modules may then respond on the basis of the control data received from the ad-hoc mesh network. The response may include immobilizing the ignition, sounding an alarm bell to notify the security personnel or any such person suggested by the end user and the like.

In accordance with an exemplary embodiment of the present invention, an automatic tracking system for tracking vehicles such as the mobile node 102 is provided. An end user of the automatic tracking system requests a location of a vehicle. The request for the location of the vehicle is received at a central monitoring station such as central monitoring station 106. The central monitoring station routes the request to the vehicle whose location information was desired by the end user, over a wireless ad-hoc mesh network formed by a plurality of vehicles (each vehicle is fitted with transceivers for communication purposes) and one or more fixed nodes such as fixed node 104. The A-GPS receiver such as the A-GPS receiver 214 in the vehicle wakes up on the reception of the request by the vehicle, and receives a GPS assistance data being broadcast over the wireless ad-hoc mesh network. A GPS unit such as the GPS unit 410 in the central monitoring station constantly tracks GPS satellites and computes the GPS assistance data. The GPS assistance data is provided by the central monitoring station to the one or more fixed nodes which broadcast the GPS assistance data over the wireless ad-hoc mesh network to be received by the A-GPS receivers in the vehicles. The location data computed by the A-GPS receiver includes the location information of the vehicle. The location data is dynamically routed over the wireless ad-hoc mesh network from the vehicle to the central monitoring station. The central monitoring station automatically processes the location data, which may include providing a visual representation of the location information using the location data received from the vehicle. The central monitoring station then provides the location of the vehicle to the end user.

Further, to secure the vehicles in events such as theft or intrusion, the vehicles may be fitted with one or more security modules such as security module 204. For instance, the vehicle may be fitted with an impact sensor for doors and windows, speed sensor and the like. The one or more security modules may detect an occurrence of a situation such as intrusion and provide situation data. This situation data along with the location data may be routed over the wireless ad-hoc mesh network from the vehicle to the central monitoring station. The central monitoring station automatically processes the situation data and the location data to identify the vehicle, the vehicle owner and type of situation and such other information, and notifies the appropriate personnel of the occurrence of the situation along with location information. The end user may then send instruction to the central monitoring station to be relayed to the one or more security modules, such as immobilizing the ignition, thereby securing the vehicle. The automatic tracking information thereby provides on-demand vehicle location information and also provides means for securing the vehicle.

In accordance with an another exemplary embodiment of the present invention, the system 100 and the automatic tracking system explained above, include direct communication between the mobile node 102 (such as the vehicle) with the central monitoring station. The plurality of mobile nodes 102, configure a wireless ad-hoc mesh network for dynamic routing of the location data, the situation data and/or the control data. The central monitoring station in this case broadcasts the GPS assistance data to the plurality of mobile nodes for the computation of the location data. The computed location data is dynamically routed over the wireless ad-hoc mesh network to the central monitoring station, which then provides a notification to an end user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, and to thereby enable others skilled in the art to best utilize the invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

1. An automatic tracking and security system, comprising:
a plurality of mobile nodes in operative communication with at least one fixed node, the plurality of mobile nodes and the at least one fixed node configuring a wireless ad-hoc mesh network; and
a central monitoring station, the central monitoring station in operative communication with the wireless ad-hoc mesh network;
wherein each of the plurality of mobile nodes comprises at least one security module and is capable of providing a real-time response to a situation data of a situation sensed by the at least one security module; and
wherein the central monitoring station is capable of providing Global Positioning System (GPS) assistance data to the plurality of mobile nodes over the wireless ad-hoc mesh network; and
wherein each of the plurality of mobile nodes is further capable of computing a location data using the GPS assistance data; and
wherein the wireless ad-hoc mesh network is capable of dynamically routing the location data and/or the situation data from the plurality of mobile nodes to the central monitoring station; and
wherein the central monitoring station is further capable of
automatically processing the location data and/or the situation data, and
providing a notification to an end user.

2. The automatic tracking and security system of claim 1, wherein at least one of the plurality of mobile nodes is a vehicular unit.

3. The automatic tracking and security system of claim 1, wherein the at least one fixed node is a cellular base station.

4. The automatic tracking and security system of claim 1, wherein the at least one fixed node is capable of communicating on at least one frequency.

5. The automatic tracking and security system of claim 1, wherein the central monitoring station comprises a GPS unit for computing the GPS assistance data.

6. The automatic tracking and security system of claim 1, wherein the central monitoring station provides the GPS assistance data to the plurality of mobile nodes by broadcasting the GPS assistance data over the wireless ad-hoc mesh network.

7. The automatic tracking and security system of claim 6, wherein the at least one fixed node receives the GPS assistance data from the central monitoring station and broadcasts the GPS assistance data over the wireless ad-hoc mesh network.

8. The automatic tracking and security system of claim 1, wherein the wireless ad-hoc mesh network is capable of dynamically routing the location data and/or situation data by defining at least one alternate path for routing the location data and/or situation data to the central monitoring station, in an event of failure of at least one of the plurality of mobile nodes and/or the at least one fixed node.

9. The automatic tracking and security system of claim 1, wherein the wireless ad-hoc mesh network is further capable of
determining a newly added mobile node and/or fixed node;
integrating the newly added mobile node and/or fixed node into the wireless ad-hoc mesh network; and
updating existing routes for routing the location data and/or situation data to the central monitoring station.

10. The automatic tracking and security system of claim 1, wherein the notification to the end user comprises a location of the mobile node and/or occurrence of the situation.

11. The automatic tracking and security system of claim 1, wherein the notification to the end user is provided by the central monitoring station using at least one of a short message service, a multimedia message service, a video clip, a phone call, a text message and a world wide web.

12. The automatic tracking and security system of claim 1, wherein the notification to the end user is provided by the central monitoring station whenever the central monitoring station receives a request for the notification from the end user.

13. The automatic tracking and security system of claim 1, wherein the notification to the end user is automatically provided by the central monitoring station.

14. The automatic tracking and security system according to claim 1, wherein the central monitoring station is further capable of generating a control data and dynamically routing the control data over the wireless ad-hoc mesh network to the plurality of mobile nodes.

15. The automatic tracking and security system of claim 14, wherein the central monitoring station is further capable of processing an instruction received from the end user and generating the control data based on the instruction received from the end user.

16. The automatic tracking and security system of claim 14, wherein the central monitoring station is further capable of generating the control data based on an occurrence of at least one predefined situation.

17. The automatic tracking and security system according to claim 14, wherein the at least one security module is capable of modifying a state of the mobile node based on the control data received from the central monitoring station over the wireless ad-hoc mesh network.

18. An automatic tracking and security system, comprising:
a plurality of mobile nodes configuring a wireless ad-hoc mesh network; and
a central monitoring station, the central monitoring station in operative communication with the wireless ad-hoc mesh network;
wherein each of the plurality of mobile nodes comprises at least one security module and is capable of providing a real-time response to a situation data of a situation sensed by the at least one security module; and
wherein the central monitoring station is capable of providing Global Positioning System (GPS) assistance data to the plurality of mobile nodes over the wireless ad-hoc mesh network; and
wherein each of the plurality of mobile nodes is further capable of computing a location data using the GPS assistance data; and
wherein the wireless ad-hoc mesh network is capable of dynamically routing the location data and/or the situation data from the plurality of mobile nodes to the central monitoring station; and
wherein the central monitoring station is further capable of
automatically processing the situation data and/or location data, and
providing a notification to an end user.

19. An automatic tracking system, comprising:
a plurality of mobile nodes in operative communication with at least one fixed node, the plurality of mobile nodes and the at least one fixed node configuring a wireless ad-hoc mesh network; and
a central monitoring station, the central monitoring station in operative communication with the wireless ad-hoc mesh network;
wherein the central monitoring station is capable of providing Global Positioning System (GPS) assistance data to the plurality of mobile nodes over the wireless ad-hoc mesh network; and
wherein each of the plurality of mobile nodes is further capable of computing a location data using the GPS assistance data; and
wherein the wireless ad-hoc mesh network is capable of dynamically routing the location data from the plurality of mobile nodes to the central monitoring station; and
wherein the central monitoring station is further capable of
automatically processing the location data, and
providing a location of a mobile node of the plurality of mobile nodes to an end user.

20. The automatic tracking system of claim 19, wherein at least one of the plurality of mobile nodes is a vehicular unit.

21. The automatic tracking system of claim 19, wherein the at least one fixed node is a cellular base station.

22. The automatic tracking system of claim 19, wherein the at least one fixed node is capable of communicating on at least one frequency.

23. The automatic tracking system of claim 19, wherein the central monitoring station comprises a GPS unit for computing the GPS assistance data.

24. The automatic tracking system of claim 19, wherein the central monitoring station provides the GPS assistance data to the plurality of mobile nodes by broadcasting the GPS assistance data over the wireless ad-hoc mesh network.

25. The automatic tracking system of claim 24, wherein the at least one fixed node receives the GPS assistance data from the central monitoring station and broadcasts the GPS assistance data over the wireless ad-hoc mesh network.

26. The automatic tracking system of claim 19, wherein the wireless ad-hoc mesh network is capable of dynamically routing the location data by defining at least one alternate path for routing the location data to the central monitoring station, in an event of failure of at least one of the plurality of mobile nodes and/or the at least one fixed node.

27. The automatic tracking system of claim 19, wherein the wireless ad-hoc mesh network is further capable of
determining a newly added mobile node and/or fixed node;
integrating the newly added mobile node and/or fixed node into the wireless ad-hoc mesh network; and
updating existing routes for routing the location data to the central monitoring station.

28. The automatic tracking system of claim 19, wherein the location of the mobile node is provided to the end user by the central monitoring station using at least one of a short message service, a multimedia message service, a video clip, a phone call, a text message and a world wide web.

29. The automatic tracking system of claim 19, wherein the location of the mobile node is provided to the end user by the central monitoring station whenever the central monitoring station receives a request for the location of the mobile node from the end user.

30. The automatic tracking system of claim 19, wherein the central monitoring station is capable of automatically providing the location of the mobile node.

31. The automatic tracking system of claim 19, wherein the central monitoring station is further capable of generating a control data and dynamically routing the control data over the wireless ad-hoc mesh network to the plurality of mobile nodes.

32. The automatic tracking of claim 31, wherein the central monitoring station is further capable of processing an instruction received from the end user and generating the control data based on the instruction received from the end user.

33. The automatic tracking of claim 31, wherein the central monitoring station is further capable of generating the control data based on an occurrence of at least one predefined situation.

34. The automatic tracking system of claim 31, wherein each of some of the mobile nodes comprises at least one security module.

35. The automatic tracking system of claim 34, wherein the at least one security module is capable of modifying a state of the mobile node based on a control data received from the central monitoring station over the wireless ad-hoc mesh network.

36. An automatic tracking system, comprising:
a plurality of mobile nodes configuring a wireless ad-hoc mesh network; and
a central monitoring station, the central monitoring station in operative communication with the wireless ad-hoc mesh network;
wherein the central monitoring station is capable of providing Global Positioning System (GPS) assistance data to the plurality of mobile nodes over the wireless ad-hoc mesh network; and
wherein each of the plurality of mobile nodes is further capable of computing a location data using the GPS assistance data; and
wherein the wireless ad-hoc mesh network is capable of dynamically routing the location data from the plurality of mobile nodes to the central monitoring station; and
wherein the central monitoring station is further capable of
automatically processing the location data, and
providing a location of a mobile node of the plurality of mobile nodes to an end user.

37. A method for providing a notification to an end user, the method comprising:
providing a Global Positioning System (GPS) assistance data to a mobile node of a plurality of mobile nodes, wherein the GPS assistance data is provided by a central monitoring station to the plurality of mobile nodes over a wireless ad-hoc mesh network configured by the plurality of mobile nodes and at least one fixed node;
computing a location data, wherein the mobile node computes location data using the GPS assistance data received over the wireless ad-hoc mesh network from the central monitoring station;
sensing an occurrence of a situation and sending a situation data, wherein the sensing is performed by at least one security module comprised in the mobile node;
dynamically routing the location data and/or situation data over the wireless ad-hoc mesh network to the central monitoring station;
processing automatically the situation data and/or location data and providing the notification to an end user, wherein the central monitoring station automatically processes the situation data and/or the location data; and
notifying the end user.

38. The method of claim 37, wherein the mobile node is a vehicular unit.

39. The method of claim 37, wherein the at least one fixed node is a cellular base station.

40. The method of claim 37, further comprising at least one fixed node communicating on at least one frequency.

41. The method of claim 37, further comprising computing the GPS assistance data by the central monitoring station using a GPS unit.

42. The method of claim 37, further comprising broadcasting the GPS assistance data by the central monitoring station to the plurality of mobile nodes over the wireless ad-hoc mesh network.

43. The method of claim 42, further comprising the central monitoring station providing the GPS assistance data to at least one fixed node, wherein the at least one fixed node broadcasts the GPS assistance data to the plurality of mobiles nodes over the wireless ad-hoc mesh network.

44. The method of claim 37, further comprising defining at least one alternate path for dynamically routing the location and/or situation data over the wireless ad-hoc mesh network to the central monitoring station, in an event of failure of at least one of the mobile nodes and/or fixed node.

45. The method of claim 37, further comprising performing dynamic routing over by the wireless ad-hoc mesh network by
determining a newly-added mobile node and/or fixed node;
integrating the newly added mobile node and/or fixed node into the wireless ad-hoc mesh network; and
updating existing routes for routing the location data and/or situation data to the central monitoring station.

46. The method of claim 37, wherein the notifying the end user comprises providing a location of the mobile node and/or occurrence of the situation.

47. The method of claim 37, wherein the end user is notified by the central monitoring station using at least one of a short message service, a multimedia message, a video clip, a phone call, a text message and a world wide web.

48. The method of claim 37, wherein the end user is notified by the central monitoring station on receiving a request for the notification from the end user.

49. The method of claim 37, wherein the end user is automatically notified by the central monitoring station.

50. The method of claim 37, further comprising generating a control data by the central monitoring station and dynamically routing the control data over the wireless ad-hoc mesh network to the mobile node.

51. The method of claim 50, further comprising receiving an instruction from the end user by the central monitoring station and generating the control data based on the instruction received from the end user.

52. The method of claim 50, further comprising generating control data on the occurrence of a predefined situation, wherein the control data is generated by the central monitoring station.

53. The method of claim 50, further comprising responding to the control data by the at least one security module, wherein the at least one security module modifies a state of the mobile node based on the control data.

54. A method for providing a notification to end user, the method comprising:
providing a Global Positioning System (GPS) assistance data to a mobile node of the plurality of mobile nodes, wherein the GPS assistance data is provided by a central monitoring station to the plurality of mobile nodes over a wireless ad-hoc mesh network configured by the plurality of mobile nodes;
computing a location data, wherein the mobile node computes location data using the GPS assistance data received over the wireless ad-hoc mesh network from the central monitoring station;
sensing a situation and sending a situation data, wherein the sensing is performed by at least one security module comprised in the mobile node;
dynamically routing the location data and/or situation data over the wireless ad-hoc mesh network to the central monitoring station;
processing automatically the situation data and/or location data and providing the notification to an end user, wherein the central monitoring station automatically processes the situation data and/or location data; and
notifying the end user.
